(19) United States
(12) Patent Application Publication
(10) Pub. No.: US 2016/0211727 A1
(43) Pub. Date: Jul. 21, 2016

(54) MOTOR ASSEMBLY

(71) Applicant: ZF Friedrichshafen AG, Friedrichshafen (DE)

(72) Inventor: Thomas MAIER, Nuenburg v. Wald (DE)

(73) Assignee: ZF Friedrichshafen AG, Friedrichshafen (DE)

(21) Appl. No.: 15/000,630

(22) Filed: Jan. 19, 2016

(30) Foreign Application Priority Data
Jan. 20, 2015 (DE) 102015200866.5

(51) Int. Cl. H02K 9/22; H02K 11/22; H02K 11/30; H02K 11/00; H02K 5/04; H02K 11/21

(52) U.S. Cl. CPC H02K 9/22; H02K 5/04; H02K 11/21; H02K 11/30; H02K 11/0094; H02K 11/022

(57) ABSTRACT

A motor assembly is proposed, having a motor disposed in a housing, with an electronics system and a cooling element, wherein the cooling element and the electronics system are coated with a coating material to form a media-tight unit, and wherein the media-tight unit is attached to the housing of the motor at the cooling element side.

### PRIORITY STATEMENT

This application claims the benefit of German Patent Application DE 10 2015 200 866.5, filed Jan. 20, 2015, and incorporates the German Patent Application by reference herein in its entirety.

### FIELD

The present invention relates to a motor assembly having a motor disposed in a housing.

### BACKGROUND

By way of example, an assembly for accommodating the power and control electronics of an electric motor is known from WO 2004/025812 A1. With the known assembly, a direct current motor is provided, the power electronics and control electronics of which are disposed in a receiving space provided between the direct current motor and the cooling element. The cooling element has cooling fins on the side facing away from the receiving space for the power electronics and control electronics, evenly distributed about its circumference, the intermediate spaces between which are subjected to a flow of ambient air. In this manner, the exhaust heat occurring in the power electronics and control electronics is discharged in a convective manner into the environment via the cooling element.

The disadvantage with this assembly is that, with the use of the assembly in a transmission, for example, or another environment exhibiting high ambient temperatures, it is not possible to discharge the heat into the environment, such that an overheating of the assembly occurs, which decreases the lifetime. Moreover, the seal requires structurally complex covers and seals as well as additional components, which is not only expensive, but also requires substantial structural space, and thus significantly limits the scope of application.

### SUMMARY

The present disclosure addresses the object of proposing a motor assembly of the type described above, in which a sufficient heat discharge for the electronics system is also ensured in high ambient temperatures, and furthermore has a structurally simple design.

A motor assembly having a motor disposed in a housing, e.g. an electric motor having an electronics system and a cooling element, is proposed, wherein the cooling element and the electronics system are coated with a coating material to form a media-tight unit, wherein the media-tight unit is attached to the housing of the motor at the cooling element side thereof.

The proposed motor assembly has a permanently integrated, no longer removable, sealed and media-tight unit comprising the cooling element and electronics system, wherein the cooling element is disposed such that the heat from the electronics system can be discharged directly to the housing. The integrated cooling element is ideally disposed between the motor and the electronics system, and basically serves as a screw connection between the motor housing and the electronics system. The media-tight unit is not only inexpensive and safe regarding environmental effects, but it also offers the further advantage that a cooling of the motor housing is implemented via the unit, due to a defined heat sink with good heat discharge characteristics. No further sealing of the electronic components in the electronics system is needed due to the coating of the cooling element and electronics system, which reduces the production costs. In addition, a compact construction is obtained, requiring a minimum of structural space.

Furthermore, a printed circuit board provided in the electronics system can also be populated on both sides, because it is entirely coated, together with the cooling element. The cooling element is preferably made of aluminum, for example, designed as an aluminum pressure die cast component, in order to ensure an optimal heat discharge. The cooling element can also serve as an electromagnetic (“EMC”) shield due to its design as a unit in accordance with the present disclosure, in order to shield the entire assembly from electrical and/or magnetic fields.

In accordance with an advantageous further development of the present disclosure, it is provided that the cooling element is attached to an open flange side of the motor housing, such that the heat from the electronics system is discharged via the cooling element to the motor housing forming the heat sink. In this manner, the cooling element fulfills the function of implementing a heat dissipation and heat discharge toward the motor housing and to the connecting flange of the housing, on one hand, because the motor housing has a stable flange temperature. As a further function, the cooling element forms a sealing plane to the motor housing, or the cover thereof, which closes off the open motor housing and the cooling element, as well as attaching the electronics system to the motor housing. It is also conceivable, for example, that the coating of the unit comprising the cooling element and the electronics system is expanded to also cover the connecting region between the motor housing and the cooling element.

With the proposed motor assembly, the electronics system can have so-called reverse MOSFETs, for example, which can discharge the resulting heat direction to the cooling element in an advantageous manner. The so-called power MOSFETs are specialized metal oxide semiconductor field effect transistors, which exhibit a particularly high power density. As further transistors, electrolyte transistors and/or so-called SMD capacitors may be provided. The aforementioned components can be mounted as electronic components on a printed circuit board for the electronics system in a manner that is efficient in terms of structural space, e.g. on the surface thereof. The electronics system thus form at least the power electronics and the control electronics for the motor.

The proposed motor assembly can advantageously be used in vehicle transmissions, in which high ambient temperatures and aggressive environmental conditions prevail due to the presence of hydraulic means. Other fields of application are also conceivable. It should be understood that the description and specific examples are intended for purposes of illustration only and are not intended to limit the scope of the present disclosure.

### BRIEF DESCRIPTION OF THE DRAWINGS

FIG. 1 shows a schematic view of a possible embodiment variation of a motor assembly according to the present disclosure, having a motor 2 disposed in a housing 1, e.g. an electric motor or suchlike, having an electronics system 3 and a cooling element 4, e.g. in the form of an aluminum pressure die cast body. The proposed motor assembly can preferably be used in a transmission housing, e.g. as an actuator or suchlike.

### DETAILED DESCRIPTION OF EXAMPLE EMBODIMENTS

It is proposed in accordance with the present disclosure that the cooling element 4 and the electronics system 3 are coated with a coating material in the form of a coated region 5 forming a media-tight unit, wherein the media-tight unit is attached to the housing 1 of the motor 2 at the cooling element side.

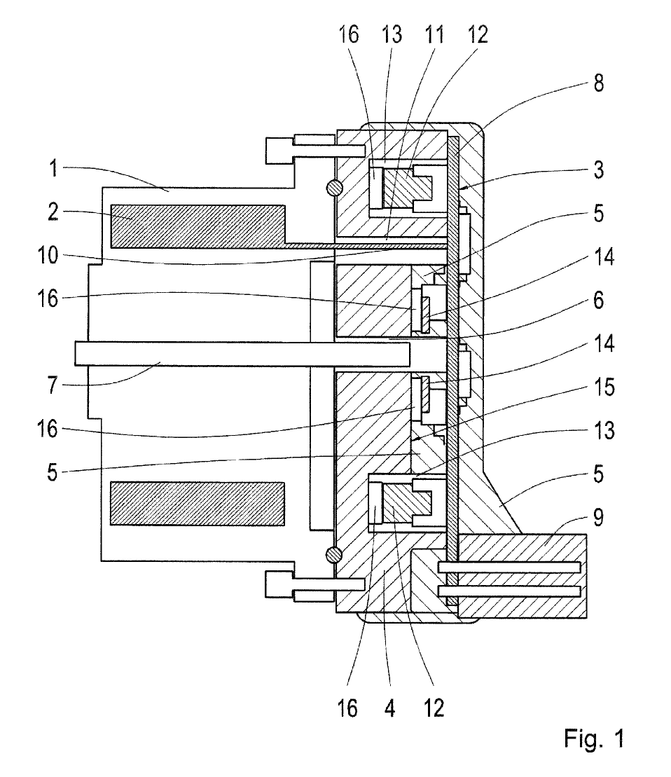

As can be seen in FIG. 1, the cooling element 4, as a unit with the electronics system 3, is attached to an open flange side of the housing 1 such that the heat from the electronics system 3 is discharged to the housing 1 of the motor 2, forming a heat sink, via the cooling element. In this manner, a cooling of the motor occurs via the coated aluminum pressure die cast component, or via the cooling element 4, respectively, due to a stable flange temperature, such that a cooling does not occur via convection to the ambient air, but rather, a particularly high heat discharge is enabled via the housing 1 of the motor 2.

The attachment of the unit comprising the cooling element 4 and electronics system 3 forms the sealing plane to the housing 1 of the motor 2 at the same time, and thus seals the open housing 1 at the flange side. As a result, a particularly simple assembly is also obtained, because only the unit is mounted directly on the housing 1 of the motor 2, and thus, there is no need for further coverings. Because the unit is coated, there is also no need for further sealing between the cooling element 4 and the electronics system 3.

The cooling element 4 has a receiving space 6 for receiving the motor shaft 7, wherein the end of the motor shaft 7 is assigned to the electronics system 3 for detecting the position of the motor shaft. In this manner, the detection of the motor position directly via the motor shaft 7 can occur by means of classic methods, e.g. with magnets glued to the motor shaft 7, or by means of inductive sensor systems, in an inexpensive manner. It is also possible that the end of the motor shaft 7 facing toward the electronics system 3 has a special shape, which can be detected via an inductive sensor in the electronics system 3.

The electronics system 3 comprises a printed circuit board 8 populated with electronic components, on which a likewise media-tight, injection molded control device plug 9 is provided. The motor windings, or the motor phase contacts 10, respectively, are guided through a hole 11 in the cooling element 4 to the printed circuit board 8 of the electronics system 3, and are connected directly to the printed circuit board 8 of the electronics system 3 via spring contacts or via press-fit connections.

The electronics system 3 comprises electrolyte capacitors 12 as components, which are connected directly to the cooling element 4 via a thermally conductive material 16. For this, the electrolyte capacitors 12 may be disposed in a recess 13 in the cooling element 4 assigned thereto, in order that they are protected prior to the coating. Furthermore, the printed circuit board 8, or the electronics system 3, respectively, comprises output stages in the form of reverse MOSFETs 14. The reverse MOSFETs 14 are disposed in a recess 15 in the cooling element 4, and can discharge exhaust heat directly to the cooling element 4 via a thermally conductive material 16. The region of the recess 15 between the printed circuit board 8 and the cooling element 4 is filled with coating material 5.

### REFERENCE SYMBOLS

1 Housing
2 Motor
3 Electronics System
4 Cooling Element
5 Coating Material or Coating Region
6 Receiving Space
7 Motor Shaft
8 Printed Circuit Board
9 Control Device Plug
10 Motor Phase Contact
11 Hole
12 Electrolyte Capacitor
13 Recess
14 End stages in the form of a reverse MOSFET
15 Recess
16 Thermally Conductive Material

1. A motor assembly comprising:
a motor disposed in a housing;
an electronics system and;
a cooling element, wherein the cooling element and the electronics system are coated with a coating material to form a media-tight unit, wherein the media-tight unit is attached to the housing of the motor at the cooling element side.

2. The motor assembly according to claim 1, wherein the cooling element is attached at an open flange side of the housing, such that heat from the electronics system can be discharged via the cooling element to the housing of the motor, which forms a heat sink.

3. The motor assembly according claim 1, wherein the cooling element has a receiving space for receiving a motor shaft wherein one end of the motor shaft is assigned to the electronics system for detecting a position of the motor shaft.

4. The motor assembly according to claim 3, wherein the end of the motor shaft facing toward the electronics system has a shape which can be detected via an inductive sensor in the electronics system.

5. The motor assembly according to claim 1, wherein the motor phase contacts are guided through a hole in the cooling element, and connected directly to a printed circuit board of the electronics system via spring contacts.

6. The motor assembly according to claim 1, wherein the motor phase contacts are guided through a hole in the cooling element, and connected directly to a printed circuit board of the electronics system via press-fit connections.

7. The motor assembly according to claim 1, further comprising a control device plug that is injection molded in a media-tight manner onto the coated electronics system.

8. The motor assembly according to claim 1, wherein end stages of the electronics system are designed as reverse MOSFETs, and their resulting heat can be discharged directly to the cooling element via a thermally conductive material.

9. The motor assembly according claim 1, wherein the cooling element is configured as an EMC shield.

10. The motor assembly according to claim 1, wherein the electronics system has an electrolyte capacitor, which is connected directly to the cooling element via a thermally conductive material.

11. The motor assembly according to claim 1, wherein the electronics system comprises an electrolyte capacitor, disposed in a recess in the cooling element.

12. The motor assembly according to claim 1, wherein the electronics system comprises an electrolyte capacitor in the form of an SMD capacitor.

13. The motor assembly according to claim 3, wherein the end of the motor shaft facing toward the electronics system has magnets attached to the motor shaft which can be detected by the electronics system.
